(19) United States
(12) Patent Application Publication
(10) Pub. No.: US 2015/0371107 A1
(43) Pub. Date: Dec. 24, 2015

(54) MATERIAL CLASSIFICATION USING BRDF FEATURE VECTOR

(71) Applicant: CANON KABUSHIKI KAISHA, Tokyo (JP)

(72) Inventor: SANDRA SKAFF, Mountain View, CA (US)

(21) Appl. No.: 14/312,614

(22) Filed: Jun. 23, 2014

(51) Int. Cl. G06K 9/52; G06F 17/30; G06K 9/46; G06K 9/62

(52) U.S. Cl. CPC G06K 9/52; G06K 9/6218; G06F 17/3028; G06K 9/46; G06K 9/6267; G06K 2009/4666

(57) ABSTRACT

Feature vector representations are computed for BRDF image slices in a database of known materials captured under a relatively large number of incident illumination directions. Low-level features of each image slice are clustered into at least two clusters. An intermediate feature vector representation is computed for each image slice with entries that are weighted means of the clusters.

### FIELD

The present disclosure relates to material classification, and more particularly relates to the design of a feature vector by which material classification is performed.

### BACKGROUND

In the field of material classification, classification is often performed by measuring light reflected from an object. A feature vector is derived from the measurements, and compared to feature vectors in a database of known materials.

One feature vector previously considered in this field is a feature vector composed of pixel intensities of a BRDF (Bidirectional Reflectance Distribution Function), specifically, BRDF image slices and spectral BRDF image slices. In this approach, the object is illuminated from multiple different angles by multiple different light sources arranged in a hemispherical dome around the object, leading to multiple spectral BRDF image slices. Reflected light from each light source is measured from the slices so as to form the BRDF, whereafter feature vectors are derived and the unknown material from which the object is fabricated is classified.

### SUMMARY

One problem with the conventional feature vector is its high dimensionality, particularly due to per-pixel classification of images. For example, given a relatively modest database of 150 image slices having 1000×1000 pixels in size for 100 material samples of 10 main categories, the number of samples would be 1000×1000×150=150×10⁶, for a dimensionality of the same 150×10⁶. The space required to store these samples, and the power and time required to process them, scale with the number of materials, leading to an impractical situation.

The foregoing situation is addressed by computing a feature vector representation for an image slice based on clustering of low-level features of the image slice.

Thus, in an example embodiment described herein, feature vector representations are computed for BRDF image slices in a database of known materials captured under a relatively large number of incident illumination directions. Low-level features of each image slice are clustered into two or more clusters. An intermediate feature vector representation is computed for each image slice with entries that are weighted means of the clusters.

By computing a feature vector representation for an image slice based on clustering of low-level features of the image slice, it is ordinarily possible to represent the BRDF based features of material while substantially reducing the size of the data.

In one example aspect, the low-level features of each image slice are clustered into at least two clusters such as a first cluster for specular reflections and a second cluster for diffuse reflections, or into at least three clusters such as a first cluster for specular reflections, a second cluster for diffuse reflections, and a third cluster for dark reflections.

In another example aspect, feature vector representations of each slice are computed by sorting all entries of the intermediate feature vector representations by the mean of the corresponding clusters.

In still another example aspect, a classification engine is trained for material classification using the computed feature vector representations of labeled training data.

In yet another example aspect, an object fabricated from an unknown material is illuminated, and BRDF image slices for the illuminated object are captured. A feature vector representation is computed for the BRDF image slices of the object of unknown material, and the material for the unknown object is classified by applying the feature vector representation of the unknown object to the trained classification engine.

In another example aspect, material classification includes material sub-categories. In still another example aspect, the classification engine is configured to make a decision for classification with a pre-determined level of confidence. In yet another example aspect, in response to failure of the classification engine to make a decision, the object is subjected to a manual labeling.

In still another example aspect, the number of clusters is selected automatically by using a clustering algorithm. In one example aspect, clustering includes application of K-means clustering on the low-level features for each image slice. In another example aspect, K-means clustering is applied to derive more than three clusters. In yet another example aspect, with respect to the clusters for specular reflections, diffuse reflections and dark reflections, at least one such cluster includes a sub-cluster. In still another example aspect, the low-level features include pixel intensity values of the BRDF image slices.

In another example aspect, the database of labeled training data is labeled according to classification of material by calculating a probability function based on determining a correlation between a sample signature and a set of pre-labeled signatures in a database.

In still another example aspect, the intermediate feature vectors are computed by using an algorithm selected from the group including, but not limited to, K-means algorithm and Gaussian Mixture Models.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is an example embodiment of a classification system according to the description herein, in the form of a recycling system in which objects to be recycled are classified according to the materials from which the objects are fabricated, and the classified objects are sorted for recycling according to their material classification.

FIG. 2 is a more detailed view of an object being subjected to classification at a classification station of the FIG. 1 view.

FIG. 3 is a view for explaining the architecture of a classification and sorting controller according to an example embodiment.

FIG. 4 is a view for explaining material classification according to an example embodiment.

FIG. 5 is a flow diagram for explaining material classification according to an example embodiment.

FIG. 6 is a view for explaining accuracy of a material classification according to an example embodiment.

### DETAILED DESCRIPTION

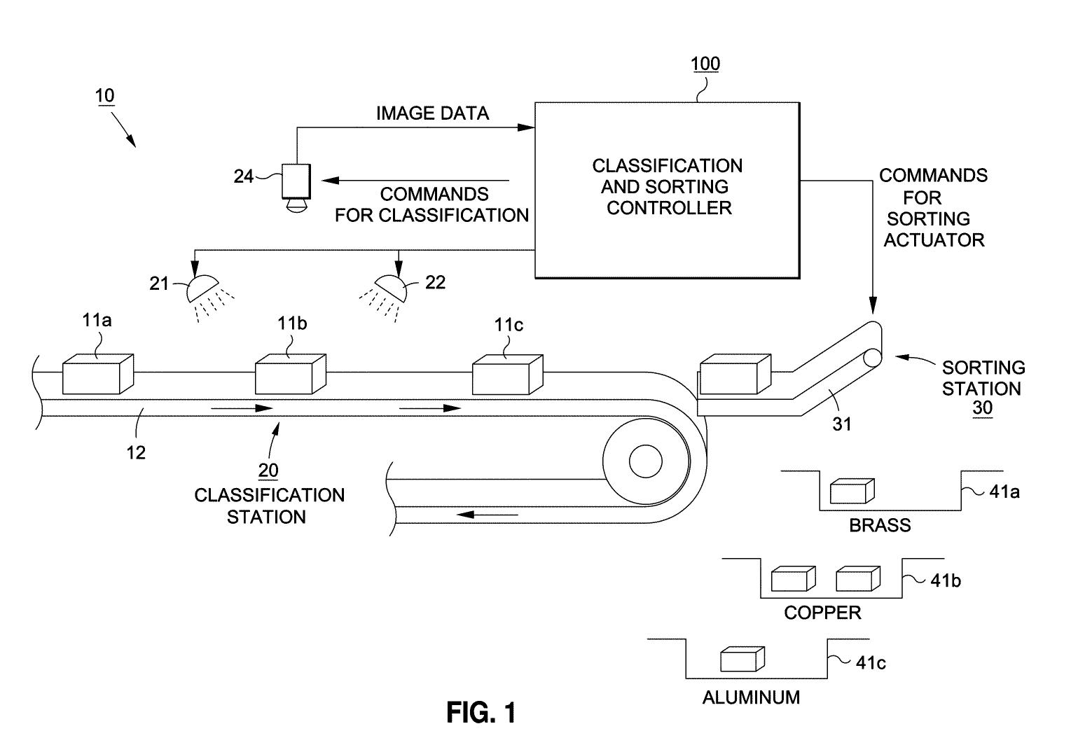

FIG. 1 is an example embodiment of a classification system according to the description herein, in the form of a recycling system 10 in which objects to be recycled are classified according to the materials from which the objects are fabricated, and the classified objects are sorted for recycling according to their material classification. As shown in FIG. 1, objects 11a, 11b, etc. are conveyed on a conveyor mechanism 12 to a classification station 20, where the objects are classified according to their material, and thence to a sorting station 30, where the objects are sorted according to their material classification. Classification station 20 includes plural light sources 21 and 22, together with a camera 24 for capturing images of objects positioned at classification station 20. The object at the classification station is illuminated individually by each of the plural light sources under control of classification and sorting controller 100, and camera 24 captures one or more images for each individual illumination. Under control of the classification and sorting controller 100, a classification is made for the material from which the object is fabricated.

Conveyor mechanism 12 continues to convey the object to sorting station 30, where sorting actuator 31 sorts the objects according to the material classification. Sorting is controlled by classification and sorting controller 100, which commands sorting actuator 31 to sort the classified objects into multiple receptacles 41a, 41b and 41c.

In this example embodiment, material classification differentiates between different types of metals from which the objects are fabricated, such as brass, copper and aluminum. Naturally, it will be understood that this is a non-limiting example. In other embodiments, material classification could differentiate between metal, plastic and glass, between fabric and paper, between different types or colors of plastics and glass, and so forth, or between any and all of these. In addition, other embodiments might include a classification of “unknown”, signifying that material classification did not succeed with confidence, with a corresponding receptacle for which manual sorting is required.

A description will now be made of the positioning of the plural light sources and the camera relative to the object at the classification station, the spectral content of the light sources, and the spectral sensitivity of the camera.

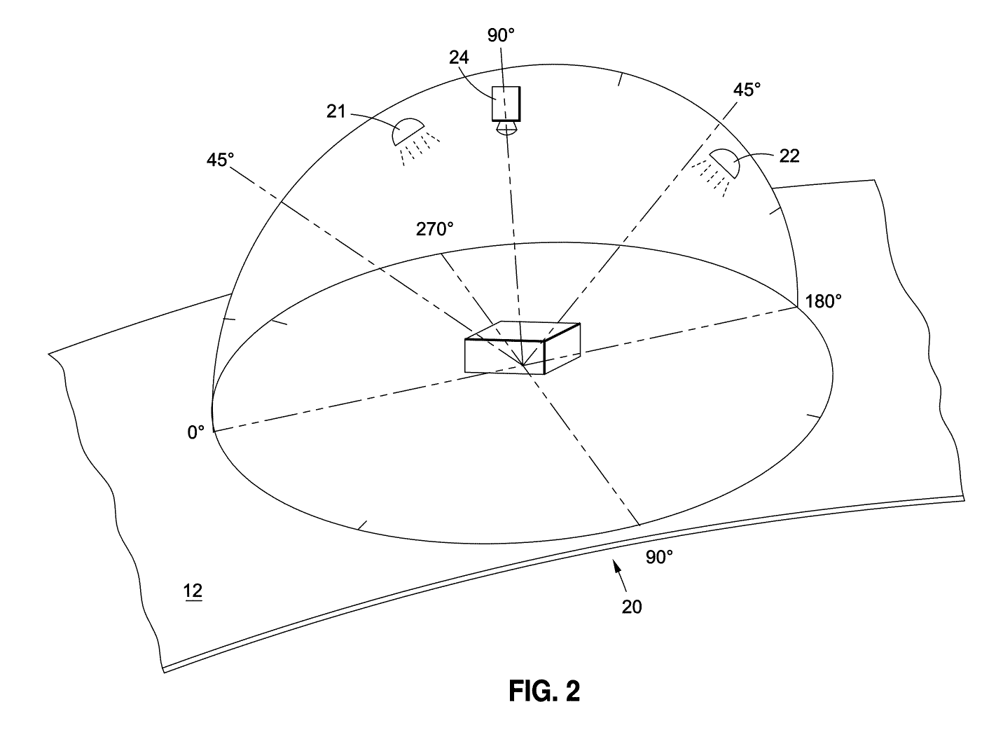

FIG. 2 is a more detailed view of an object on conveyor mechanism 12 at classification station 20. In this figure, an angular coordinate system has been superimposed for purposes of explanation, and for purposes of explaining the angle of incidence for each of light sources 21 and 22, and the angle of exitant for light reflected from the object and imaged by camera 24. In this example embodiment, light source 21 is positioned at a first incident angle, and light source 22 is positioned at a second incident angle. Also in this example, camera 24 is positioned at an exitant angle of 90 degrees elevation.

With respect to the spectral content of light sources 21 and 22, in one embodiment, each light source is formed from an LED cluster with six (6) differently-colored LEDs arranged circularly with a white LED in the center. In this embodiment, the LEDs cover the visible wavelength range, and include the colors of blue, green, yellow, red, orange and the afore-mentioned white. In other embodiments, it might be helpful to include LEDs beyond the visible wavelength, such as LEDs which emit light in the ultraviolet or infrared range. The precise spectral content of the light sources in general will assist in distinguishing between different classifications of materials.

Camera 24 in this embodiment is a RGB camera, and it thus exhibits spectral sensitivity in each of the red, green and blue wavelengths. In other embodiments, camera 24 might include spectral sensitivity in wavelengths other than red, green, and blue, or it might include a monochrome camera which exhibits broad spectral sensitivity across the visible and near-visible ranges of wavelengths, possibly along with a liquid crystal tunable filter.

As shown in FIG. 2, this example embodiment includes two (2) light sources and one (1) camera. In general, in order to facilitate rapid classification of materials, such as real-time classification of materials, the number of light sources and the number of cameras is relatively small, such that materials can be classified with only a few illuminations and with only a few images for each such illumination. Preferably, the number of light sources should range between two and five, inclusive, most preferable two or three light sources, and the number of cameras should range between one and two, inclusive, most preferably one camera.

Although in this embodiment the spectral content of each individual light source is identical to all others, it should be understood that the spectral content of the light sources might differ from each other. Likewise, in embodiments where there are plural cameras, although the spectral sensitivities of the cameras might match, it is also possible for the spectral sensitivities to differ. Certain materials might provide a stronger response depending on which LED (red, green, etc.) is illuminating, the angle (45° incident angle vs. 90° incident angle), and so on. While how the surface reflects light is a characteristic of the surface despite such variations, some combinations of colors/angles and the like will provide a clearer or stronger response than others. Generally, it might be the case that angles of illumination where the light strikes the material at a more direct angle (i.e.,) 90° illuminate more surface and are therefore more optimal, since the reflections returned have more pixels that are not dark. Additional details of variances in illumination angles and the like are discussed in U.S. application Ser. No. 14/092,492, entitled “Material Classification Using Spectral BRDF Slices” (Attorney Docket No. 03650.015372), the contents of which are incorporated herein by reference.

Under control of classification and sorting controller 100, each individual LED in each individual light source of the plural light sources is illuminated individually and independently of other LEDs in the light source, and independently and individually of other light sources and other LEDs in those other light sources. For each such illumination, camera 24 captures an image of light reflected from the object at the exitant angle. The captured images are collected by classification and sorting controller 100, and are analyzed thereby, such as by deriving one slice of the so-called bidirectional reflectance distribution function (BRDF). The BRDF is a four-dimensional function that depends on incident and exitant angles, and defines how light is reflected from the surface of an object. With a camera positioned at a fixed exitant angle, only a “slice” of the BRDF is obtained.

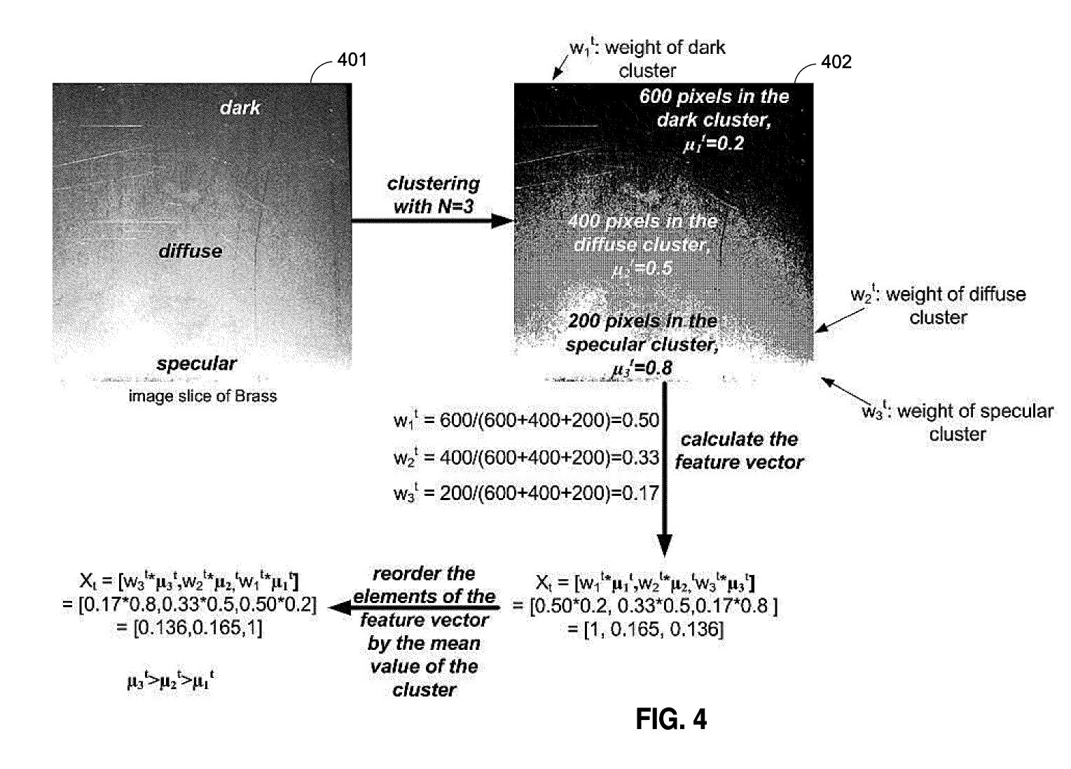

Based on the BRDF slices and other analysis, a feature extraction algorithm is applied to extract feature vectors for each image, as described more fully below with respect to FIGS. 4 to 6 and the accompanying text. The extracted feature vectors can then be fed to a trained classification engine, and classification and sorting controller 100 can obtain a classification of the material from which the illuminated object is fabricated.

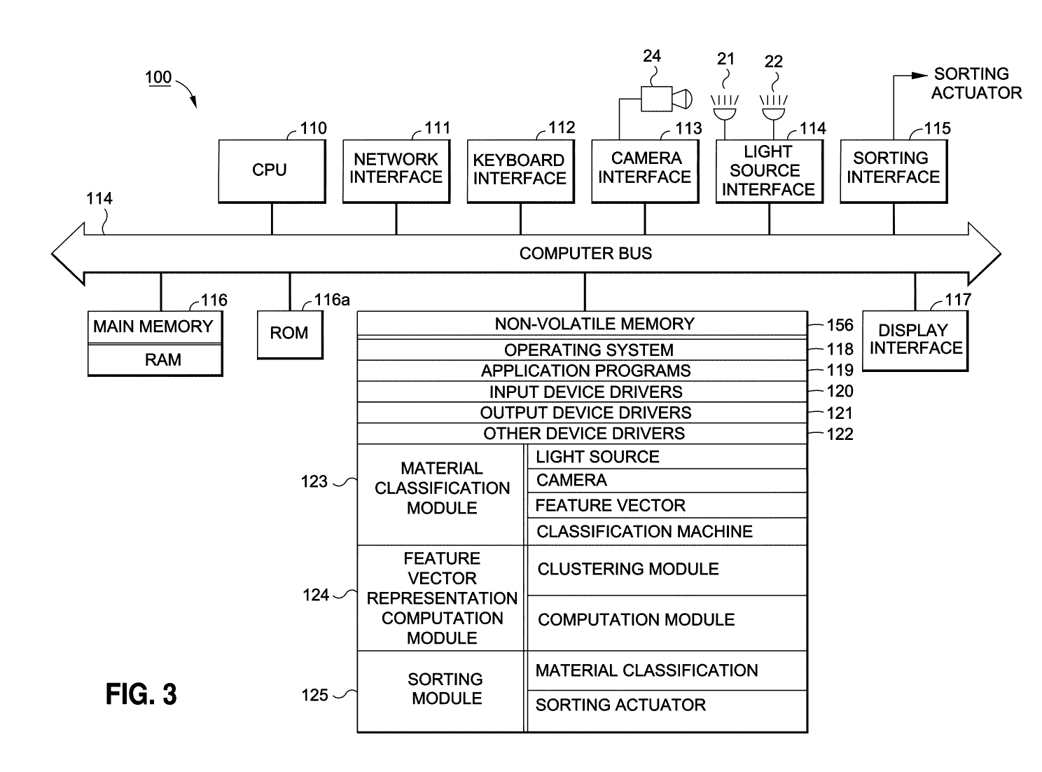

FIG. 3 is a view for explaining the architecture of classification and sorting controller 100.

As shown in FIG. 3, classification and sorting controller 100 includes central processing unit (CPU) 110 which interfaces with computer bus 114. Also interfacing with computer bus 114 are non-volatile memory 156 (e.g., a hard disk or other nonvolatile storage medium), network interface 111, keyboard interface 112, camera interface 113, random access memory (RAM) 116 for use as a main run-time transient memory, read only memory (ROM) 116a, and display interface 117 for a display screen or other output.

RAM 116 interfaces with computer bus 114 so as to provide information stored in RAM 116 to CPU 110 during execution of the instructions in software programs, such as an operating system, application programs, image processing modules, and device drivers. More specifically, CPU 110 first loads computer-executable process steps from non-volatile memory 156, or another storage device into a region of RAM 116. CPU 110 can then execute the stored process steps from RAM 116 in order to execute the loaded computer-executable process steps. Data, also, can be stored in RAM 116 so that the data can be accessed by CPU 110 during the execution of the computer-executable software programs, to the extent that such software programs have a need to access and/or modify the data.

As also shown in FIG. 3, non-volatile memory 156 contains computer-executable process steps for operating system 118, and application programs 119, such as graphic image management programs. Non-volatile memory 156 also contains computer-executable process steps for device drivers for software interface to devices, such as input device drivers 120, output device drivers 121, and other device drivers 122.

Non-volatile memory 156 also stores a material classification module 123 and a sorting module 125. The material classification module and the sorting module comprise computer-executable process steps for material classification of an object fabricated from an unknown material, and for sorting the object based on the material classification.

In addition, non-volatile memory 156 stores feature vector representation computation module 124, which includes a clustering module for clustering low-level features of each image slice into at least two clusters, and a computation module for computing an intermediate feature vector representation for each image slice with entries that are weighted means of the clusters. These processes are described more fully below.

The material classification module 123 includes a corresponding plurality of modules for control of the light sources, for control of the camera(s) and for gathering of image data of such camera(s), a module for derivation of feature vectors from, e.g., the intermediate feature vector representation, and a classification machine. The classification machine accepts as inputs the feature vectors derived by the feature vector module, and provides a classification of the material from which the object under inspection is fabricated. Sorting module 125, for its part, includes a corresponding plurality of modules related to input of material classification from the classification machine, and actuation of the sorting mechanism based on the classification.

The computer-executable process steps for these modules may be configured as part of operating system 118, as part of an output device driver in output device drivers 121, or as a stand-alone application program. These modules may also be configured as a plug-in or dynamic link library (DLL) to the operating system, device driver or application program. It can be appreciated that the present disclosure is not limited to these embodiments and that the disclosed modules may be used in other environments.

More details concerning the nature of the feature vector algorithm and the classification machine are provided below, in connection with FIGS. 4 through 6.

FIG. 4 is a view for explaining material classification according to an example embodiment.

In FIG. 4, image slice 401 is an input image slice of a material from which a feature vector will be generated. In the example shown in FIG. 4, image slice 401 corresponds to brass, although various other materials are of course possible. Image slice 401 includes pixels which generally appear to correspond to three categories, namely dark, diffuse, and specular pixels. Thus, in this example, the low-level features of each image slice are clustered into at least three clusters including a first cluster for specular reflections, a second cluster for diffuse reflections, and a third cluster for dark reflections.

As shown in FIG. 4, clustering is performed on input image slice 401. In this example, K-means clustering is performed on low-level features of the pixels with the number of clusters N specified as N=3. Accordingly, according to this example, clustering includes application of K-means clustering on low-level features for each image slice. Generally, K-means clustering aims to partition observations into N clusters in which each observation belongs to the cluster with the nearest mean (or “center”), serving as a prototype of the cluster. In the examples that follow, the low-level features include pixel intensity values of the BRDF image slices. Nevertheless, it should be understood that various other types of low-level features could be used. Moreover, other clustering methods could be used. For example, the intermediate feature vectors could be computed by using an algorithm selected from a group, including, but not limited to, K-means and Gaussian Mixture Models. In one embodiment, rather than inputting the number of clusters, the cluster means or centers can be specifically input. In addition, N can also be varied.

In that regard, the specified number of clusters N has an effect on the accuracy of the feature vector. Generally, N=3 is desirable, since most images have at least or near 3 types of reflections. However, other numbers could be used. For example, N=4 would mean that one of the specular, dark and diffuse clusters will be split into two clusters, and thus some images might lose commonality if they fall into different clusters of the split cluster. Thus, in such a case, material classification would include material sub-categories, and the K-means clustering would derive more than three clusters. In particular, the low-level features would be clustered into clusters for specular reflections, diffuse reflections and dark reflections, at least one of which including a sub-cluster. On the other hand, in some cases N=2 might be desirable if the image only contains two types of reflections (or significant numbers thereof), e.g., if the image only includes specular and diffuse reflections. In some embodiments, the number of clusters can be selected automatically by using the clustering algorithm.

The clustering naturally identifies pixels belonging to each cluster of the three clusters, as shown in clustered image 402. For example, in this example, 600 pixels are clustered into the dark (dark pixel) cluster, 400 pixels are clustered into the diffuse cluster, and 200 pixels are clustered into the specular cluster. As also shown in clustered image 402, the dark cluster has a mean pixel value μ₁^{t} of 0.2 (e.g., the mean pixel intensity), the diffuse cluster has a mean pixel value μ₁^{t} of 0.5, and the specular cluster has a mean pixel value μ₃^{t} of 0.8. In this embodiment, therefore, important features are extracted from the whole image slice, rather than needing to separate or otherwise segment portions of the image, such as by cropping out segments which include dark pixels. Naturally, the number of pixels in each cluster and mean pixel values mentioned above are only examples, and other numbers and values might be obtained.

Once the pixels are sorted into the clusters, weights can be assigned to each cluster, e.g., W₁^{t} corresponding to the weight of the dark cluster, W₂^{t} corresponding to the weight of the diffuse cluster, and W₃^{t} corresponding to the weight of the specular cluster. In this example, each of weights W₁^{t}, W₂^{t}, and W₃^{t} equals the number of pixels in the corresponding cluster divided by the total number of pixels. Thus, as shown in FIG. 4, W₁^{t}=600 pixels in the dark cluster divided by 1200 total pixels=0.5, W₂^{t}=400/1200=0.33, and W₃^{t}=200/1200=0.17.

To calculate an intermediate feature vector, the weight for each cluster is multiplied by the mean for each cluster, and the results of this computation for each cluster are concatenated. Thus, for example, the vector can be written as Xₜ=[μ₁^{t}*W₁^{t}, μ₂^{t}*W₂^{t}, . . . , μ_{N}^{t}*W_{N}^{t}], where Xₜ is the feature vector representation of image slice t and N is the number of clusters, where μ₁^{t}, μ₂^{t}, and μ₃^{t} are the mean pixel values for each cluster as discussed above, and W₁^{t}, W₂^{t}, and W₃^{t} are the weights, or percentage of pixels in each cluster for slice t.

To generate the feature vector, the elements of the intermediate feature vector are sorted by the mean value of the cluster. As described above, the dark cluster has a mean pixel value μ₁^{t} of 0.2, the diffuse cluster has a mean pixel value μ₂^{t} it of 0.5, and the specular cluster has a mean pixel value μ₃^{t} of 0.8. Thus, reordering these elements in Xₜ from highest to lowest mean value, results in Xₜ=[μ₃^{t}*W₃^{t}, μ₂^{t}*W₂^{t}, μ₁^{t}*W₁^{t}]=[(0.17*0.8), (0.33*0.5), (0.5*0.2)]=[0.136, 0.165, 1]. Accordingly, feature vector representations of each slice are computed by sorting all entries of the intermediate feature vector representations by the mean of the corresponding clusters.

In this regard, it should be noted that the elements can be sorted in other ways, although generally it is helpful if the manner of the sorting is the same for all image slices. Nevertheless, in some cases the elements of the intermediate feature vector can be used to train a classifier even if non-ordered, although such training often becomes more complex.

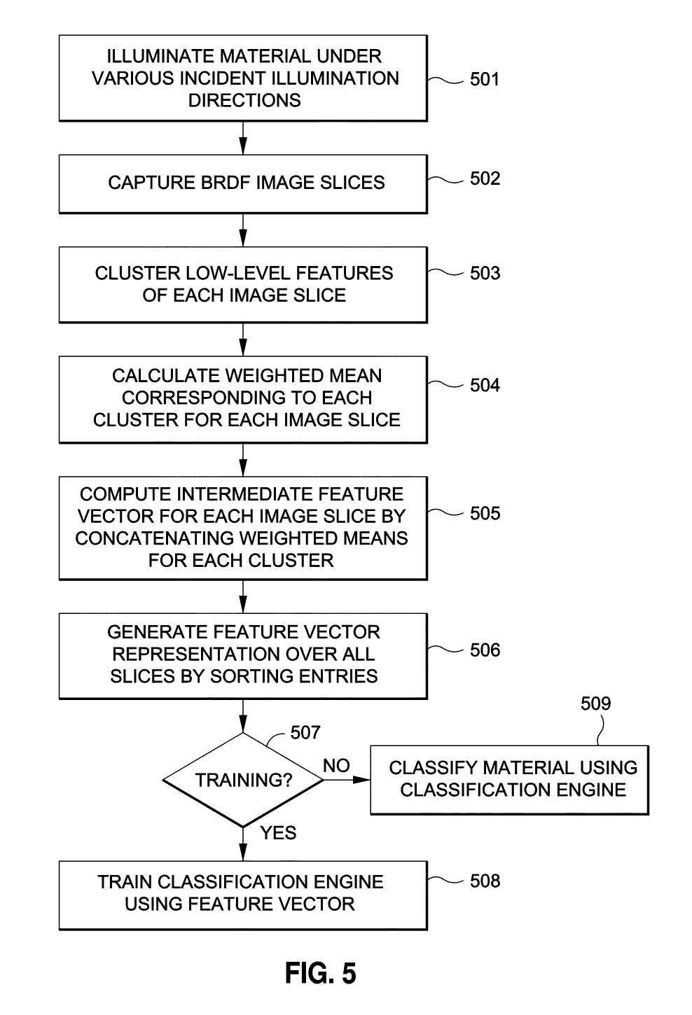

FIG. 5 is a flow diagram for explaining material classification according to an example embodiment.

Briefly, in FIG. 5, feature vector representations are computed for BRDF image slices in a database of known materials captured under a relatively large number of incident illumination directions. Low-level features of each image slice are clustered into at least two clusters. An intermediate feature vector representation is computed for each image slice with entries that are weighted means of the clusters.

In more detail, in step 501, a material is illuminated under various incident illumination directions. In particular, as mentioned above with respect to FIG. 2, each individual LED in each individual light source of the plural light sources is illuminated individually and independently of other LEDs in the light source, and independently and individually of other light sources and other LEDs in those other light sources. For each such illumination, camera 24 captures an image of light reflected from the object at the exitant angle.

In step 501, it does not matter whether the imaged material is unknown or known. Moreover, whether the material is a known training material or an unknown material to be classified, the process is the same from steps 501 to 506.

In step 502, bidirectional reflectance distribution function (BRDF) slices are captured. In particular, one slice of the BRDF may be derived. The BRDF is a four-dimensional function that depends on incident and exitant angles, and defines how light is reflected from the surface of an object. With a camera positioned at a fixed exitant angle, only a “slice” of the BRDF is obtained.

In step 503, low-level features of each image slice are clustered. In particular, as discussed above with respect to FIG. 4, K-means clustering is performed on low-level features of the image slice to identify pixels belonging to each cluster of N clusters (N being input before clustering).

In step 504, a weighted mean corresponding to each cluster for each image slice is calculated based on the pixel values in the cluster, and in step 505, an intermediate feature vector representation is computed for each image slice by concatenating the weighted means for each cluster, as also described above with respect to FIG. 4.

In step 506, the feature vector representation is generated by sorting the entries of the intermediate feature vector representation, as described above. For example, the elements of the intermediate feature vector representation can be sorted from highest to lowest mean value.

At this point, the processing to be performed depends on whether the material under consideration is a known material used for training a classification engine such as a support vector machine, or whether the material under consideration is an unknown material which is being classified. Thus, in step 507, there is a determination of whether the material is being used for training. If the material is a known material, then the material is being used for training, and the process proceeds to step 508. On the other hand, if the material is an unknown material to be classified, the process proceeds to step 509.

In step 508, the classification engine is trained using the feature vector generated in step 506. For example, a support vector machine (SVM) may be trained on the set of features of the feature vector. Thus, the approach can be used to train a classifier, and the trained classifier can be used to label data. In one example, as discussed below, the SVM can use 75% of the samples for training, and 25% for testing. At some point, there may be a need to label the training data, i.e., to input, after deriving the feature vectors, which feature vector corresponds to which material, although such labeling could also be done with an unsupervised approach. Thus, in one embodiment, a classification engine is trained for material classification using the computed feature vector representations of labeled training data. For example, the database of labeled training data can be labeled according to classification of material by calculating a probability function based on determining a correlation between a sample signature and a set of pre-labeled signatures in a database.

The classification engine may be configured to make a decision for cases with a pre-determined level of confidence in the prediction. When a decision is not made, the sample can be sent to a human for labeling.

In addition, although some embodiments may be based on a one-time training of the classification engine, in other embodiments, the classification engine may be trained more than once, or may be updated at intervals, such as by training on-line with new material samples. In this regard, and particularly with respect to objects not classified with confidence by the engine, and for which a manual classification was needed, the training for the classification engine can be updated using the manually-classified result.

On the other hand, if the feature vector is not used for training and the material is to be classified, the process proceeds to step 509, where the material is classified using the classification engine. Specifically, the material for the unknown object is classified by applying the feature vector representation of the unknown object to the classification engine. Thus, according to this embodiment, an object fabricated from an unknown material is illuminated, and BRDF image slices for the illuminated object are captured. A feature vector representation is computed for the BRDF image slices of the object of unknown material, and the material for the unknown object is classified by applying the feature vector representation of the unknown object to the trained classification engine.

While the above example describes training the classification engine with the generated feature vector, other alternatives are possible. For example, the classification engine can be trained beforehand and/or offline with labeled training samples. In another example, the classification engine need not be trained at all, and classification can be performed directly on unlabeled samples. Put another way, the unknown materials can be classified directly using their features, without training the classification engine.

A number of examples of material classification will now be described, for better evaluation of the derived feature vector.

In the examples that follow, material classification performance is compared using the feature vector calculated as described above, referred to hereafter as the multispectral histogram of reflections (msHOR). For comparison, performance is also evaluated in cases of using a mean feature vector, as will be described shortly, and a per-pixel feature vector representation.

For the comparison, binary classification is performed. 25 sets of materials of two types are constructed using materials from the RIT database, which is a dataset of spectral BRDF's of material samples published in 2012 by RIT (http://compimg1.cis.rit.edu/data/metal/). The dataset contains 100 material samples of 10 main categories. The setup for image capture constitutes a dome of 25 clusters, with 6 LED's in each cluster.

Each of the 25 sets comprises 15 sets of only non-ferrous metals and 10 sets of a combination of both non-ferrous and ferrous metals, which can be referred to as mixed metal sets. The non-ferrous metals are of three categories: four types of aluminum, brass, copper, and chromium. The mixed sets have additionally the following two ferrous metal categories: two types of steel and stainless steel. Table 1 shows the list of RIT sets used in the binary classification experiments.

TABLE 1
The 25 two-class RIT metal sets used for evaluation. The first 15 sets
comprise only non-ferrous metals, while the remainder 10 sets compris
e both ferrous and non-ferrous metals.
RIT metal sets considered

Brass/Copper
AL2024/Brass
AL2024/Copper
AL7075/Brass
AL7075/Copper
AL5052/Brass
AL5052/Copper
AL6061/Brass
AL6061/Copper
AL2024/AL5052
AL6061/AL7075
Chromium/Brass
Chromium/Copper
AL7075/Chromium
AL6061/Chromium
Steel1/Steel2
Steel1/Stainless steel
Steel2/Stainless steel
Brass/Stainless steel
Copper/Stainless steel
AL7075/Steel2
Steel1/Chromium
AL7075/Stainless steel
Steel1/Copper
Steel1/Brass

For each material category, there are 4 samples. Therefore, there are 8 samples in total. Different combinations or folds of training and test data are chosen, such that for each fold, the test data contains one sample from each category. In total, 16 folds of training and testing data are considered, where 75% of the samples are used for training, and 25% are used for testing. Therefore for each fold, a training set would have 6 material samples, while a test set would have 2 samples. The classification accuracy computed is then taken to be the average over the accuracies computed for each of the test sets of the 16 folds. The classification accuracy is computed for each class and then averaged over the two classes, to obtain the average classification accuracy per set.

Two items need to be set when using an SVM: the kernel type and the C parameter. If the dataset contains only a small number of training samples, use of a linear kernel is sufficient. As for the parameter C, it can be set to, e.g., 10.

Classification accuracies compared using different feature vectors for 4 cases will now be described below.

Case 1

In the first case, the sorted vector described above (msHOR) is compared to a similar version of the vector in which no ordering of entries is performed. The latter case implies that that the feature vectors for each image slice as calculated in step 505 above are simply concatenated to yield the overall feature vector, without sorting. This unsorted feature vector can be referred to as msHORv1. Table 2 shows results obtained for different numbers of clusters N, and for both types of feature vectors.

TABLE 2
Classification accuracies obtained using an SVM with a linear kernel,
over the RIT metal sets, for different numbers of clusters N = 2, 3, 4, 5,
and 6. Two types of feature vectors are considered: the first version of the
Histogram Of Reflections (msHORv1), where the entries of the vectors
are not ordered by descending order of cluster means; and the second
version of the Histogram Of Reflections (msHOR), where the entries of
the vectors are in decreasing order of cluster means.

| Feature | Number of clusters | | | | |
|---|---|---|---|---|---|
| vector type | N = 2 (%) | N = 3 (%) | N = 4 (%) | N = 5 (%) | N = 6 (%) |
| msHORv1 | 80 | 72 | 67 | 70 | 66 |
| msHOR | 80 | 81 | 75 | 75 | 75 |

Two observations can be made from the results shown. First, ordering the entries of the feature vector (msHOR) provides better classification performance than when the entries are not ordered (msHORv1). Second, the best classification accuracy is obtained for the msHOR feature vector and in the case N=3. This result supports the hypothesis that pixels of an image slice can generally be attributed to one of three types of reflections or clusters. The performance degrades significantly and plateaus when N increases for both the cases of msHOR and msHORv1.

Case 2

In the second case, the msHOR (when N=3) feature vector is compared to a mean feature vector. The mean feature vector is calculated by concatenating the means of the pixel intensity values over all image slices. The main drawback in using the mean feature vector is that an appropriate region, which is not full of non-reflective image regions for example, of each stack of image slices needs to be manually cropped to obtain the best image representation. The classification results are compared using the mean feature vector for three sets to the results obtained with using the msHOR features.

TABLE 3
Classification accuracies obtained when using an SVM with a linear
kernel, for three binary sets of non-ferrous metals from the RIT database,
as computed over 16 folds. Two types of feature vectors are considered:
the mean where the feature vectors are computed as the concatenation
of the means over cropped regions of the BRDF slice images; and the
msHOR feature vector computed as the concatenation of the HOR
feature vectors over all 150 slices.

| Feature Vector | Brass/ | | |
|---|---|---|---|
| Type | Copper (%) | AL7075/Copper (%) | AL7075/Brass (%) |
| Mean | 91 | 78 | 75 |
| msHOR | 97 | 78 | 78 |

Table 3 shows that the classification accuracies obtained when using the new feature vector are as at least the same or higher than when using the mean feature vector. In this regard, it can be noted the mean feature vector is 150 dimensions, while the msHOR feature vector is 450 dimensions (150 for each type of reflectance).

Case 3

In order to gain a better understanding of the performance of the msHOR in classifying the 25 sets of metals as shown in Table 1, another version of the mean feature vector can be calculated, referred to as Mean_v2. As mentioned earlier, the original mean feature vector requires manual cropping for each image slice after identifying the appropriate region for cropping. As this is tedious to perform in practice for all materials, the mean feature vector Mean_v2 can be calculated across the full image without cropping, and the means from all slices can be concatenated. Table 4 shows the average classification accuracy over the 25 sets in the case of using each feature vector. It should be noted the dimensional size of this Mean_v2 feature vector is 150D, while that of msHOR is 450D.

TABLE 4
Classification accuracies obtained using an SVM with a linear kernel,
over all 25 binary sets of metals from the RIT database, as computed over
16 folds. Two types of feature vectors are considered: the mean where
the feature vectors are computed as the concatenation of the means
over the BRDF slice image pixel intensity values; and the msHOR
feature vector.

| Feature Vector | |
|---|---|
| Type/Binary set | Overall (%) |
| Mean_v2 | 76 |
| msHOR, N = 3 | 81 |

Thus, in this example case, the msHOR is more accurate than the Mean_v2 feature vector.

Case 4

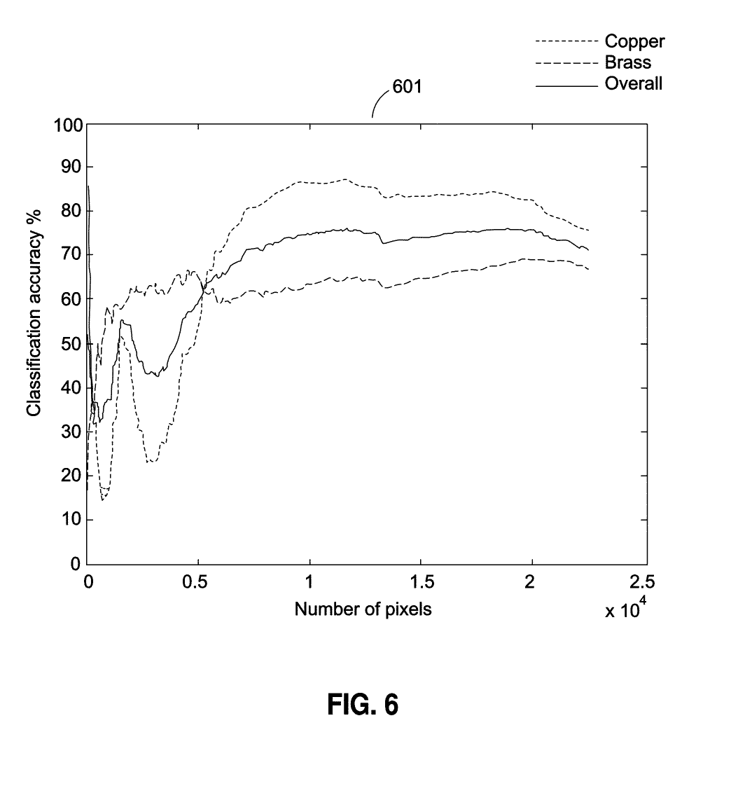

Case 4 is directed to evaluation of a per-pixel feature vector representation. In particular, FIG. 6 depicts results when classifying brass and copper samples using feature vectors comprising the image pixels, and specifically using different numbers of pixels, starting 1 pixel per image to 22500 pixels.

In that regard, FIG. 6 depicts accuracies computed for classifying brass and copper samples which are comprised of different numbers of pixels. The reported accuracies are for the brass and copper categories as well as the mean accuracy for both, as a function of the number of pixels.

FIG. 6 shows how classification accuracy varies with the change in the number of pixels taken. The highest overall classification accuracy obtained was 76% when using 11,701 pixels. Thus, per-pixel feature vector representation does not necessarily provide as good of accuracy as the msHOR. Moreover, as described above, the space required to store the samples and the power and time required to process them scale with the number of materials, and can be impractical.

In contrast, by computing a feature vector representation for an image slice based on clustering of low-level features of the image slice, it is ordinarily possible to represent the BRDF based features of material while substantially reducing the size of the data. Moreover, the BRDF based feature described herein relates as much as possible to the physical meaning of BRDF. This feature vector is computed for one image as a whole, and therefore used to obtain one label per image. It therefore differs from the approaches in the literature which attempt at classifying each pixel of a material sample.

Meanwhile, it is also ordinarily possible to reduce the dimensionality of the training and testing data used in the classification algorithm. This would result in decreasing both the training and test time. Decreasing the training time would be useful in case of, for example, deployment of an online training material classifier. Decreasing the test time is important when a classifier is deployed in a factory setting for recycling.

In addition, a conventional alternative to classifying each image as a whole is taking a mean feature vector, for example, to represent the material. However, such methods require manual cropping of appropriate image regions. Additionally, the classification results are sensitive to the cropped regions. On the other hand, the algorithm for the proposed feature vector ordinarily does not require manual cropping of image regions.

### OTHER EMBODIMENTS

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for computing feature vector representations for BRDF image slices in a database of known materials captured under a relatively large number of incident illumination directions, the method comprising:
clustering low-level features of each image slice, the low-level features of each image slice being clustered into at least two clusters; and
computing an intermediate feature vector representation for each image slice with entries that are weighted means of the clusters.

2. The method according to claim 1, wherein the low-level features of each image slice are clustered into at least three clusters including a first cluster for specular reflections, a second cluster for diffuse reflections, and a third cluster for dark reflections.

3. The method according to claim 1, further comprising:
computing feature vector representations of each slice by sorting all entries of the intermediate feature vector representations by the mean of the corresponding clusters.

4. The method according to claim 3, further comprising training a classification engine for material classification, wherein the classification engine is trained using the computed feature vector representations of labeled training data.

5. The method according to claim 4, further comprising illuminating an object fabricated from an unknown material and capturing BRDF image slices for the illuminated object;
computing a feature vector representation for the BRDF image slices of the object of unknown material; and
classifying the material for the unknown object by applying the feature vector representation of the unknown object to the trained classification engine.

6. The method according to claim 5, wherein material classification includes material sub-categories.

7. The method according to claim 5, wherein the classification engine is configured to make a decision for classification with a pre-determined level of confidence.

8. The method according to claim 5, wherein in response to failure of the classification engine to make a decision, the object is subjected to a manual labeling.

9. The method according to claim 1, wherein the number of clusters is selected automatically by using a clustering algorithm.

10. The method according to claim 9, wherein clustering includes application of K-means clustering on the low-level features for each image slice.

11. The method according to claim 10, wherein K-means clustering is applied to derive at least two clusters.

12. The method according to claim 11, wherein the low-level features are clustered into clusters for specular reflections, diffuse reflections and dark reflections, at least one of which including a sub-cluster.

13. The method according to claim 1, wherein the low-level features include pixel intensity values of the BRDF image slices.

14. The method according to claim 4, wherein the database of labeled training data is labeled according to classification of material by calculating a probability function based on determining a correlation between a sample signature and a set of pre-labeled signatures in a database.

15. The method according to claim 1, wherein the intermediate feature vectors are computed by using an algorithm selected from the group including, but not limited to, K-means algorithm and Gaussian Mixture Models.

16. An apparatus for computing feature vector representations for BRDF image slices in a database of known materials captured under a relatively large number of incident illumination directions, the apparatus comprising:
a computer-readable memory constructed to store computer-executable process steps; and
a processor constructed to execute the process steps stored in the memory,
wherein the process steps cause the processor to:
cluster low-level features of each image slice, the low-level features of each image slice being clustered into at least two clusters; and
compute an intermediate feature vector representation for each image slice with entries that are weighted means of the clusters.

17. The apparatus according to claim 16, wherein the low-level features of each image slice are clustered into at least three clusters including a first cluster for specular reflections, a second cluster for diffuse reflections, and a third cluster for dark reflections.

18. The apparatus according to claim 16, further comprising:
computing feature vector representations of each slice by sorting all entries of the intermediate feature vector representations by the mean of the corresponding clusters.

19. The method according to claim 18, further comprising training a classification engine for material classification, wherein the classification engine is trained using the computed feature vector representations of labeled training data.

20. A non-transitory computer-readable storage medium on which is stored computer-executable process steps for causing a computer to perform a method for identifying an unknown material using texture, the method comprising:
clustering low-level features of each image slice, the low-level features of each image slice being clustered into at least two clusters; and
computing an intermediate feature vector representation for each image slice with entries that are weighted means of the clusters.
